(19) United States
(12) Patent Application Publication
(10) Pub. No.: US 2015/0125504 A1
(43) Pub. Date: May 7, 2015

(54) BICOMPONENT FIBERS, PRODUCTS FORMED THEREFROM AND METHODS OF MAKING THE SAME

(71) Applicant: Essentra Porous Technologies Corp., Colonial Heights, VA (US)

(72) Inventors: Bennett C. Ward, Midlothian, VA (US); Brenton D. Dillie, Richmond, VA (US)

(21) Appl. No.: 14/536,297

(22) Filed: Nov. 7, 2014

Related U.S. Application Data
(60) Provisional application No. 61/901,108, filed on Nov. 7, 2013.

(51) Int. Cl. D01F 8/12; B01D 39/16; D01F 8/06; D04H 13/00; A01N 25/34; D01F 8/14

(52) U.S. Cl. CPC D01F 8/12; A01N 25/34; D01F 8/14; D01F 8/06; D04H 13/00; B01D 39/163
USPC 424/411; 428/373; 442/364; 428/36.1; 210/507; 55/528

(57) ABSTRACT

Melt blown bicomponent fibers comprising a first thermoplastic polymeric material and a second thermoplastic polymeric material comprising homo- or co-polymer(s) of poly(m-xylene adipamide) or polyphenylene sulfide. The first thermoplastic polymeric material may be one or more homo- or co-polymer(s) of nylon 6 (polycaprolactam), nylon 6,6 (poly(hexamethylene adipamide)), polypropylene, and/or polybutylene terephthalate. A plurality of bicomponent fibers may thermally bonded to one another at spaced apart points of contact to define a porous structure that substantially resists crushing. The nonwoven fabric webs and rovings and self-supporting, three-dimensional porous elements may be formed from the plurality of bicomponent fibers.

### CROSS-REFERENCE TO RELATED APPLICATIONS

This application claims the benefit under 35 U.S.C. §119(e) of U.S. Provisional Application No. 61/901,108, filed Nov. 7, 2013, the entire contents of which are incorporated by reference as if fully set forth herein.

### FIELD OF THE INVENTION

This invention relates to bicomponent fibers, to webs, rovings and self-supporting three-dimensional products formed therefrom, and to methods of making the same.

### BACKGROUND

Bicomponent fibers are generally understood to refer to filaments which are produced by extruding two polymer systems from the same spinneret, with both polymer systems being contained within the same filament. Bicomponent fibers provide vast possibilities for creating fibers with various desired chemical and physical characteristics and geometric configurations, as different polymer systems can be used to exploit capabilities not existing in either polymer system alone. Moreover, bicomponent fibers may be produced using a melt blowing process in order to attenuate the extruded fibers within a range of desired cross-sectional diameters.

While bicomponent fibers may be engineered to desired end uses, there are a number of factors which may be considered in the selection of polymers, such as polymer adhesion, melting points, shrinkage, the relative moduli of the polymers, and the final configuration of the fiber, to name just a few.

One use of bicomponent fibers is in the production of nonwoven fabrics. Nonwoven fabrics refer to fabrics which, in contrast to woven fabrics, are bonded together by chemical, mechanical, heat or solvent treatment. Nonwoven fabrics typically lack strength unless densified or reinforced by a backing or a structural frame. Thus, where nonwoven materials are formed into three-dimensional products (e.g., filters), structural reinforcements are required to support and maintain the nonwoven materials into the desired shape and under operating conditions (e.g., a range of pressures, temperatures, etc.). Such structural reinforcements, however, may be undesirable since they may interfere with filter efficiency and may introduce impurities.

For example, melt blown polypropylene monocomponent fibers have been used in the production of a variety of products, including fine particle air and liquid filters, and high absorbing body fluid media, such as those found in diapers. Such fibers, however, have low stiffness and very low recovery when compressed. Moreover, they are not easily susceptible to thermal bonding and are difficult to bond by chemical means. Thus, while they have been used in the production of thin, porous non-woven webs, they have not been commercially acceptable for the production of self-supporting, three-dimensional items such as ink reservoirs, wicks, or flat or corrugated filter sheets or direct formed filter tubes exhibiting high crush strength properties.

### BRIEF SUMMARY

In one embodiment, a melt blown bicomponent fiber comprises a first thermoplastic polymeric material and a second thermoplastic polymeric material. The second thermoplastic material comprises poly(m-xylene adipamide). The melt blown bicomponent fiber has a sheath-core configuration. The core comprises the first thermoplastic material and the sheath comprises the second thermoplastic polymeric material.

In accordance with a first separate aspect, the sheath completely surrounds the core.

In accordance with a second separate aspect, the first thermoplastic polymeric material has a first melting point and the second thermoplastic polymeric material has a second melting point. The first melting point is lower than the second melting point.

In accordance with a third separate aspect, the first thermoplastic polymeric material is one or more homo- or co-polymer(s) of nylon 6 (polycaprolactam), nylon 6,6 (poly(hexamethylene adipamide)), polypropylene, and/or polybutylene terephthalate.

In another embodiment, a nonwoven fiber web or roving comprises a plurality of any one of the foregoing melt blown bicomponent fibers bonded to one another. The plurality of the melt blown bicomponent fibers may be thermally bonded to one another at spaced apart points of contact to define a porous structure that substantially resists crushing.

In yet another embodiment, a self-supporting, three-dimensional porous element is formed from the nonwoven fiber web or roving. The self-supporting, three-dimensional porous element may be used to form an ink reservoir, wicks for medical or diagnostic test devices, wicks for air freshener or insecticide delivery devices, or a filter or filter element.

In a further embodiment, a polymeric fiber comprises a first thermoplastic polymeric material and a second thermoplastic polymeric material. The second thermoplastic polymeric material comprises homo- or co-polymer(s) of poly(m-xylene adipamide) or polyphenylene sulfide.

In accordance with a first separate aspect, the first thermoplastic polymeric material is one or more homo- or co-polymer(s) of nylon 6 (polycaprolactam), nylon 6,6 (poly(hexamethylene adipamide)), polypropylene, and/or polybutylene terephthalate.

In accordance with a second separate aspect, the fiber is a melt blown bicomponent fiber.

In accordance with a third separate aspect, the melt blown bicomponent fiber has a sheath-core configuration. The core comprises the first thermoplastic polymeric material and the sheath comprises the second thermoplastic polymeric material.

In accordance with a fourth separate aspect, the sheath completely encases or surrounds the core.

In accordance with a fifth separate aspect, the melt blown bicomponent fiber has a configuration selected from the group consisting of: sheath-core, side-by-side, sheath-core multi-lobal, and tipped multi-lobal.

In accordance with a sixth separate aspect, the melt blown bicomponent fiber has a side-by-side configuration comprising first and second portions. The first portion comprises the first thermoplastic material and the second portion comprises the second thermoplastic material.

In a further embodiment, a nonwoven web of heterogeneous fibers comprises a plurality of bicomponent fibers and a plurality of fibers. The plurality of bicomponent fibers comprise a first thermoplastic polymeric material and a second thermoplastic polymeric material comprising homo- or co-polymer(s) of poly(m-xylene adipamide) or polyphenylene sulfide. The plurality of fibers comprise a third thermoplastic polymeric material.

In accordance with a first separate aspect, the first and third thermoplastic material each have a melting point that is lower than a melting point for the second thermoplastic polymeric material.

In accordance with a second separate aspect, the first and third thermoplastic polymeric material are each separately selected from one or more homo- or co-polymer(s) of nylon 6 (polycaprolactam), nylon 6,6 (poly(hexamethylene adipamide)), polypropylene, and polybutylene terephthalate.

In accordance with a third separate aspect, the bicomponent fibers each comprise a core comprising the first thermoplastic polymeric material and a sheath comprising the second thermoplastic polymeric material, wherein the sheath completely surrounds the core.

In accordance with a fourth separate aspect, the first and third thermoplastic polymeric materials comprise the same thermoplastic polymeric material.

In yet a further embodiment, a self-supporting, three-dimensional porous element comprising any one of the preceding nonwoven web of heterogeneous fibers is provided. The bicomponent fibers are thermally bonded to one another and to the plurality of fibers at spaced apart points of contact to define a porous structure that substantially resists crushing.

In yet a further embodiment, a self-supporting, three-dimensional porous element consists of a non-woven web of fibers, the fibers comprising bicomponent fibers comprising a first thermoplastic polymeric material and a second thermoplastic polymeric material. The second thermoplastic polymeric material comprises homo- or co-polymer(s) of poly(m-xylene adipamide) or polyphenylene sulfide. In one embodiment, the porous element does not include a structural frame or core that is separate from the non-woven web of fibers. In another embodiment, the porous element does not comprise layers in addition to the non-woven web of fibers.

In accordance with a first separate aspect, a melting point of the first thermoplastic polymeric material is lower than a melting point of the second thermoplastic polymeric material.

In accordance with a second separate aspect, the thermoplastic polymeric material is one or more homo- or co-polymer(s) of nylon 6 (polycaprolactam), nylon 6,6 (poly(hexamethylene adipamide)), polypropylene, and/or polybutylene terephthalate.

In accordance with a third separate aspect, the fibers further comprise a plurality of fibers comprising a third thermoplastic polymeric material.

In accordance with a fourth separate aspect, the third thermoplastic polymeric material is one or more homo- or co-polymer(s) of nylon 6 (polycaprolactam), nylon 6,6 (poly(hexamethylene adipamide)), polypropylene, and/or polybutylene terephthalate.

In accordance with a fifth separate aspect, the third thermoplastic polymeric material is a monocomponent fiber.

Other objects, features and advantages of the described preferred embodiments will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

Illustrative embodiments of the present disclosure are described herein with reference to the accompanying drawings, in which:

FIG. 1 depicts end elevation views of various configurations of sheath-core bicomponent fibers.

FIG. 2 is a perspective view of one form of a sheath-core bicomponent fiber.

FIG. 3 is an end elevation view of a tri-lobal or “Y” shaped bicomponent fiber.

FIG. 4 depicts end elevation views of side-by-side bicomponent fibers of various different configurations.

FIG. 5 depicts an end elevation view of a tipped multi-lobal bicomponent fiber.

FIG. 6 is a perspective view of a self-supporting, three-dimensional porous element with a hollow core.

FIG. 7 is a schematic view of one form of a process line for producing rods from bicomponent fibers.

FIG. 8 is an enlarged schematic view of the sheath-core melt blown die portion of the process line of FIG. 7.

FIG. 9 is an enlarged schematic view of a split die element for forming bicomponent fibers according to the instant invention.

FIG. 10 is a schematic cross-sectional view of a steam-treating apparatus which can be used for bonding and forming a continuous porous rod.

FIG. 11 is a schematic view of an alternate heating means in the nature of a dielectric oven for bonding and forming the continuous porous rod.

Like numerals refer to like parts throughout the several views of the drawings.

### DETAILED DESCRIPTION OF THE EMBODIMENTS

Specific, non-limiting embodiments of the present invention will now be described with reference to the drawings. It should be understood that such embodiments are by way of example and are merely illustrative of but a small number of embodiments within the scope of the present invention. Various changes and modifications obvious to one skilled in the art to which the present invention pertains are deemed to be within the spirit, scope and contemplation of the present invention as further defined in the appended claims.

Embodiments of polymeric fibers and products manufactured from such fibers by thermal bonding are disclosed herein. In one embodiment, the polymeric fibers are bicomponent fibers, preferably sheath-core bicomponent fibers having a core of a thermoplastic polymeric material and a sheath of poly(m-xylene adipamide) or a copolymer thereof, or polyphenylene sulfide or a copolymer thereof. In another embodiment, the polymeric fibers are bonded solely by thermal means.

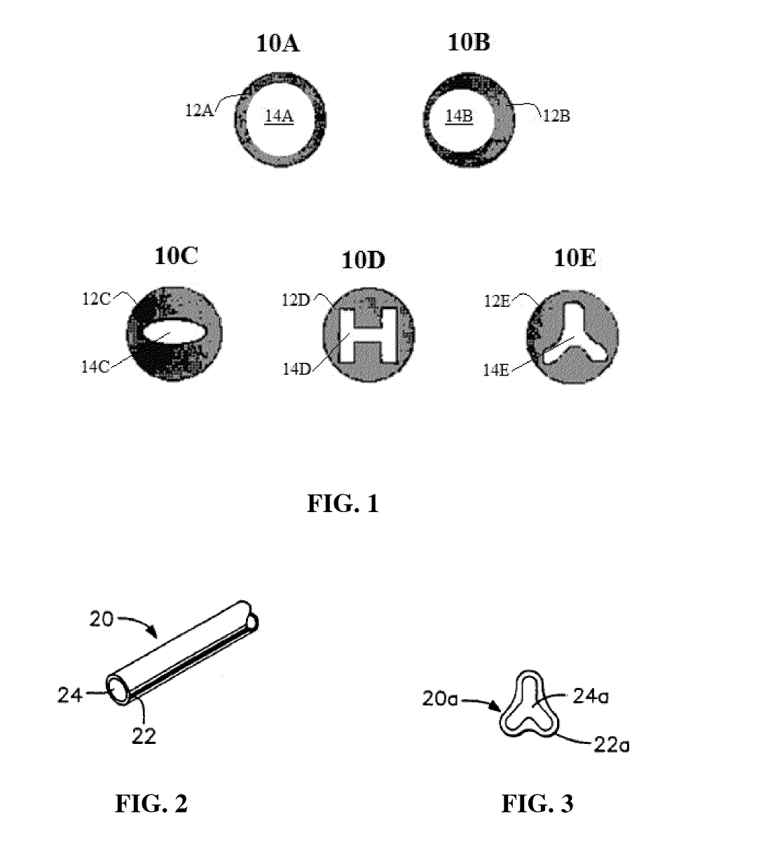

The term “bicomponent” as used herein refers to the use of two different polymer systems having different chemical properties placed in discrete portions of a fiber structure. Different configurations of the two polymer systems in bicomponent fibers are possible, including sheath-core, side-by-side, segmented pie, segmented cross, sheath-core multi-lobal, and tipped multi-lobal configurations. FIGS. 1-5 depict certain ones of the various configurations for the bicomponent fibers.

In one embodiment, the bicomponent fiber is a sheath-core fiber in which a sheath of a homo- or co-polymer of poly(m-xylene adipamide) is spun to completely surround and encompass a core of relatively low cost, low shrinkage, high strength thermoplastic polymeric material such as homo- or co-polymer(s) of nylon 6 (polycaprolactam), nylon 6,6 (poly(hexamethylene adipamide)), polypropylene or polybutylene terephthalate. In another embodiment, the bicomponent fiber is a sheath-core fiber in which a sheath of homo- or co-polymer of polyphenylene sulfide is spun to completely surround and encompass a core of relatively low cost, low shrinkage, high strength thermoplastic polymeric material such as homo- or co-polymer(s) of nylon 6 (polycaprolactam), nylon 6,6 (poly(hexamethylene adipamide)), polypropylene or polybutylene terephthalate. The bicomponent fiber may be produced using a “melt blown” fiber process to attenuate the extruded fiber to a desired diameter. In one embodiment, the extruded bicomponent fiber is highly attenuated to have an average diameter about 5 to about 40 microns, of about 6 to about 25 microns or of about 7 to about 15 microns.

The term “melt blown” as used herein refers to the use of a high pressure gas stream at the exit of a fiber extrusion die to attenuate or thin out fibers while they are in their molten state. U.S. Pat. Nos. 3,595,245, 3,615,995, 3,972,759, 4,795,668, 5,607,766 disclose the melt blowing processes. Each of the foregoing patents are incorporated herein by reference in their entireties as if fully set forth herein.

MAP MX Nylon grades S6011 and S6003LD (different grades of poly(m-xylene adipamide)), made by Mitsubishi Gas Chemical Americas, Inc., may be used as the sheath-forming material. The peak melting point (DSC) of poly(m-xylene adipamide) is 237° C., which is well above polypropylene (166° C.), nylon 6 (polycaprolactam) (220° C.) and polybutylene terephthalate (223° C.). Polyphenylene sulfide has a melting point of 280° C., which is also well above the aforementioned polymers and also above nylon 6,6 (poly(hexamethylene adipamide)).

In one specific embodiment, the sheath-core bicomponent fibers comprise a continuous sheath of a higher melting point polymer over a core of a lower melting point and low shrinkage polymer. In one example of this embodiment, a sheath of a homo- or co-polymer(s) of poly(m-xylene adipamide) can be provided over a polymer core of nylon 6 (polycaprolactam), polypropylene, and/or polybutylene terephthalate. In another example of this embodiment, a sheath of a polyphenylene sulfide can be provided over a polymer core of nylon 6 (polycaprolactam), nylon 6,6 (poly(hexamethylene adipamide)), polypropylene, and/or polybutylene terephthalate. Such fibers, particularly when melt blown, are adapted for the production of webs or rovings and elements therefrom useful for diverse commercial applications.

With respect to embodiments of the bicomponent fibers, it is understood that any one of the sheath material (e.g., homo- and co-polymer(s) of poly(m-xylene adipamide) or polyphenylene sulfide) may be used in combination with any one of the core material of a thermoplastic polymeric material (e.g., homo- and co-polymers of thermoplastic polymers, such as nylon 6 (polycaprolactam), nylon 6,6 (poly(hexamethylene adipamide)), polypropylene, and/or polybutylene terephthalate). It is not critical to utilize sheath and core materials having the same melt viscosity, as each polymer is prepared separately in the bicomponent melt blown fiber process. It may be desirable, however, to select a core material of a melt index that is similar to the melt index of the sheath polymer, or, if necessary, to modify the viscosity of the sheath polymer to be similar to that of the core material in order to insure compatibility in the melt extrusion process through the bicomponent die. Additives may be incorporated into the polymer prior to extrusion to provide the fibers and products produced therefrom with desired properties, such as increased hydrophilicity or hydrophobicity.

In the embodiments where a co-polymer of poly(m-xylene adipamide) or polyphenylene sulfide are used, the co-polymer may be selected such that its melting point is higher than a melting point of the second portion (e.g., core) of the bicomponent fiber.

FIGS. 1-5 depict the various configurations that are possible with bicomponent fibers. It is understood that the relative proportions of the bicomponent fibers are not drawn to scale and that they are depicted merely to show the relative spatial relationship between the two portions of the bicomponent fibers.

FIGS. 1-3 which depict various configurations of a sheath-core bicomponent fiber. The size of the fiber and the relative proportions of the sheath and core portions have been exaggerated for illustrative clarity. FIG. 1 depicts bicomponent fibers having five different sheath-core configurations (10A-E) comprising a core of various shapes and positions (14A-E) that is completely surrounded by a sheath (12A-E). FIG. 2 depicts a bicomponent sheath-core fiber 20 with a core 25 that is entirely surrounded by a sheath 22. In one preferred embodiment, the volume of the core is about 50-80% of the total volume of the sheath-core bicomponent fiber and the volume of the sheath is about 20-50% of the total volume of the sheath-core bicomponent fiber. In another preferred embodiment, the volume of the core is about 60-80% of the total volume of the sheath-core bicomponent fiber and the volume of the sheath is about 20-40% of the total volume of the sheath-core bicomponent fiber. In a further preferred embodiment, the volume of the core is about 70-85% of the total volume of the sheath-core bicomponent fiber and the volume of the sheath comprises 15-30% of the total volume of the sheath-core bicomponent fiber.

It is observed that in each of the embodiments depicted in FIGS. 1-2, the outer surface of the fiber is substantially cylindrical. It is understood, however, that the outer surface of the bicomponent fibers are not so limited to assume a cylindrical shape and that other outer surface shapes are possible. For example, a multi-lobal shape may be provided, as depicted in FIG. 3. The bicomponent fiber of FIG. 3, more specifically, is a tri-lobal or “Y” shaped fiber 20a comprising a sheath 22a and a core 24a. Regardless of the shape, the sheath comprises a homo- or co-polymer of poly(m-xylene adipamide) or polyphenylene sulfide which preferably entirely surrounds the core material of a thermoplastic homo- or co-polymer.

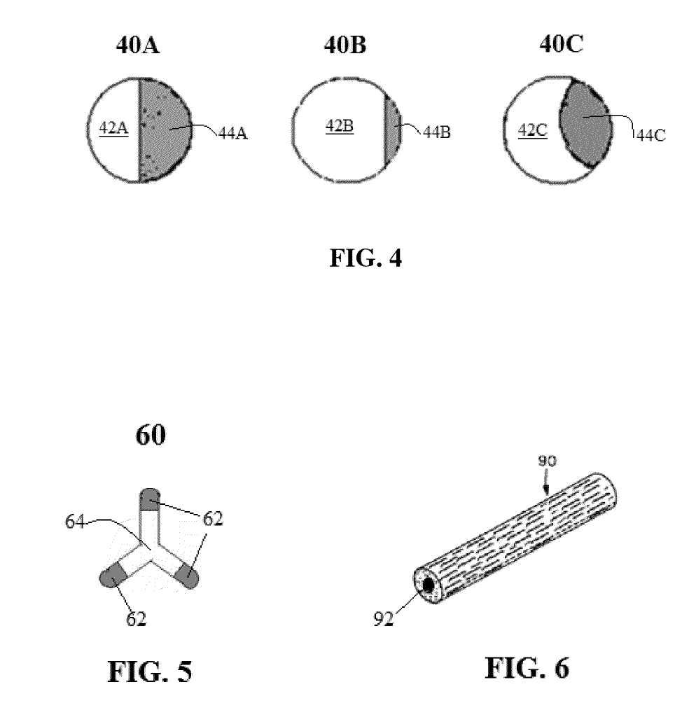

FIG. 4 depicts another embodiment of bicomponent fibers which may be used to produce the webs, rovings or self-supporting, three-dimensional porous elements disclosed herein. The bicomponent fibers (40A-C) are variations of the side-by-side configuration in which each of the two polymer systems are exposed. In a preferred embodiment, the first fiber portion (42A-C) may comprise homo- or co-polymers of poly(m-xylene adipamide) or polyphenylene sulfide and the second fiber portion (44A-C) may comprise a different thermoplastic polymeric material, such as homo- or co-polymers of nylon 6 (polycaprolactam), nylon 6,6 (poly(hexamethylene adipamide)), polypropylene, and/or polybutylene terephthalate). In another embodiment, the second fiber portion (44A-C) may comprise homo- or co-polymers of poly(m-xylene adipamide) or polyphenylene sulfide and the first fiber portion (42A-C) may comprise a different thermoplastic polymeric material, such as homo- or co-polymers of nylon 6 (polycaprolactam), nylon 6,6 (poly(hexamethylene adipamide)), polypropylene, and/or polybutylene terephthalate).

The main difference between the two foregoing embodiments is the relative proportion or volume of the two fiber portions in 40A-C and thus the relative proportions of the two different polymer systems. In bicomponent fiber 40A, the volume of the first and second portions, and thus the two polymer systems, are substantially equal.

In the bicomponent fiber of 40B and 40C, the two embodiments reflect the varying amounts of the two polymer systems that may be present. In one aspect of the embodiment, the bicomponent fiber of 40B, the volume of the first fiber portion 42B is about 80-95% of the total volume of the bicomponent fiber and the volume second fiber portion 44B is about 5-20% of the total volume of the bicomponent fiber.

In the bicomponent fiber of 40C, the volume of the first fiber portion 42C is about 65-80% of the total volume of the bicomponent fiber and the volume second fiber portion 44C is about 20-35% of the total volume of the bicomponent fiber.

In one embodiment, the volume of the first fiber portion (42B or 42C) is about 50-80% of the total volume of the bicomponent fiber and the volume of the second fiber portion (44B or 44C) is about 20-50% of the total volume of the bicomponent fiber. In another embodiment, the volume of the first fiber portion (42B or 42C) is about 60-80% of the total volume of the bicomponent fiber and the volume of the second fiber portion (44B or 44C) is about 20-40% of the total volume of the bicomponent fiber. In a further embodiment, the volume of the first fiber portion (42B or 42C) is about 70-85% of the total volume of the bicomponent fiber and the volume of the second fiber portion (44B or 44C) is about 15-30% of the total volume of the sheath-core bicomponent fiber

FIG. 5 depicts a further embodiment of a tipped multi-lobal bicomponent fiber 60 which may be used to produce the webs, rovings, or self-supporting, three-dimensional porous elements disclosed herein. The multi-lobal bicomponent fiber 60 comprises a plurality of tips 62 and a central body 64. In one embodiment, the tips 62 may comprise homo- or co-polymers of poly(m-xylene adipamide) or polyphenylene sulfide and the central body 64 may comprise a different thermoplastic polymeric material, such as homo- or co-polymers of nylon 6 (polycaprolactam), nylon 6,6 (poly(hexamethylene adipamide)), polypropylene, and/or polybutylene terephthalate). In another embodiment, the central body 64 comprises homo- or co-polymers of poly(m-xylene adipamide) or polyphenylene sulfide and the tips 62 may comprise a different thermoplastic polymeric material, such as homo- or co-polymers of nylon 6 (polycaprolactam), nylon 6,6 (poly(hexamethylene adipamide)), polypropylene, and/or polybutylene terephthalate).

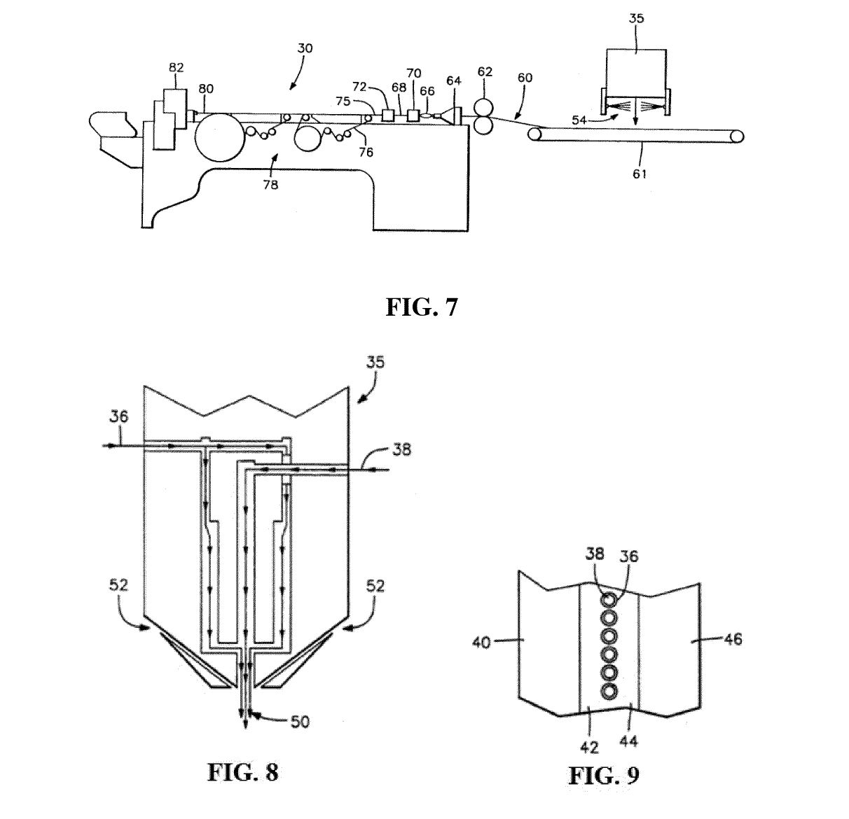

FIGS. 7 through 11 schematically illustrate an example of equipment used in making a bicomponent fiber, and processing the same into continuous, three-dimensional, porous elements, that can be subsequently subdivided to form, for example, ink reservoir elements to be incorporated into marking or writing instruments, or tobacco smoke filter elements to be incorporated into filtered cigarettes or the like. The overall processing line is designated generally by the reference numeral 30 in FIG. 7. In the embodiment shown, the bicomponent fibers themselves are made in-line with the equipment utilized to process the fibers into the porous elements. Such an arrangement is practical with the melt blown techniques because of the small footprint of the equipment required for this procedure. While the in-line processing has commercial advantages, it is to be understood that, in their broadest sense, bicomponent fibers and webs or rovings formed from such fibers may be separately made and processed into diverse products in separate or sequential operations.

Whether in-line or separate, the fibers themselves can be made using standard fiber spinning techniques for forming sheath-core bicomponent filaments as seen, for example, in Powell U.S. Pat. No. 3,176,345 or 3,192,562 or Hills U.S. Pat. No. 4,406,850 (the '345, '562 and '850 patents, respectively, the subject matters of which are incorporated herein in their entirety by reference). For example, reference is made to the aforementioned '245, '995 and '759 patents as well as Schwarz U.S. Pat. Nos. 4,380,570 and 4,731,215, and Lohkamp et al, U.S. Pat. No. 3,825,379 (the '570, '215 and '379 patents, respectively, the subject matters of which are incorporated herein in their entirety by reference). These references are to be considered to be illustrative of techniques and apparatus for forming of bicomponent fibers and melt blowing for attenuation that may be used, and are not to be interpreted as limiting thereon.

In any event, one form of a sheath-core melt blown die is schematically shown enlarged in FIGS. 8 and 9 at 35. Molten sheath-forming polymer 36, and molten core-forming polymer 38 are fed into the die 35 and extruded therefrom through a pack of four split polymer distribution plates shown schematically at 40, 42, 44 and 46 in FIG. 9 which may be of the type discussed in the aforementioned '850 patent.

Using melt blown techniques and equipment as illustrated in the '759 patent, the molten bicomponent sheath-core fibers 50 are extruded into a high velocity air stream shown schematically at 52, which attenuates the fibers 50, enabling the production of fine bicomponent fibers on the order of 12 microns or less. Preferably, a water spray shown schematically at 54, is directed transversely to the direction of extrusion and attenuation of the melt blown bicomponent fibers 50. The water spray cools the fibers 50 to enhance entanglement of the fibers while minimizing bonding of the fibers to one another at this point in the processing, thereby retaining the fluffy character of the fibrous mass and increasing productivity.

If desired, a reactive finish may be incorporated into the water spray to make the poly(m-xylene adipamide) or polyphenylene sulfide fiber surface more hydrophilic or “wettable.” Even a lubricant or surfactant can be added to the fibrous web in this manner, although unlike spun fibers which require a lubricant to minimize friction and static in subsequent drawing operations, melt blown fibers generally do not need such surface treatments. The ability to avoid such additives is particularly important, for example, in medical diagnostic devices where these extraneous materials may interfere or react with the materials being tested.

On the other hand, even for certain medical applications, treatment of the fibers or the three-dimensional elements, either as they are formed or subsequently, may be necessary or desirable. Thus, while the resultant product may be a porous element which readily passes a gas such as air, it is possible by surface treatment or the use of a properly compounded sheath-forming polymer, to render the fibers hydrophobic so that, in the absence of extremely high pressures, it may function to preclude the passage of a selected liquid. Such a property is particularly desirable when a porous element is used, for example, as a vent filter in a pipette tip or in an intravenous solution injection system. The materials to so-treat the fiber are well known and the application of such materials to the fiber or porous element as they are formed is well within the skill of the art.

Additionally, a stream of a particulate material such as granular activated charcoal or the like (not shown) may be blown into the fibrous mass as it emanates from the die, producing excellent uniformity as a result of the turbulence caused by the high pressure air used in the melt blowing technique. Likewise, a liquid additive such as a flavorant or the like may be sprayed onto the fibrous mass in the same manner.

The melt blown fibrous mass is continuously collected as a randomly dispersed entangled web or roving 60 on a conveyor belt shown schematically at 61 in FIG. 7 (or a conventional screen covered vacuum collection drum as seen in the '759 patent, not shown herein) which separates the fibrous web from entrained air to facilitate further processing. This web or roving 60 of melt blown bicomponent fibers is in a form suitable for immediate processing without subsequent attenuation or crimp-inducing processing.

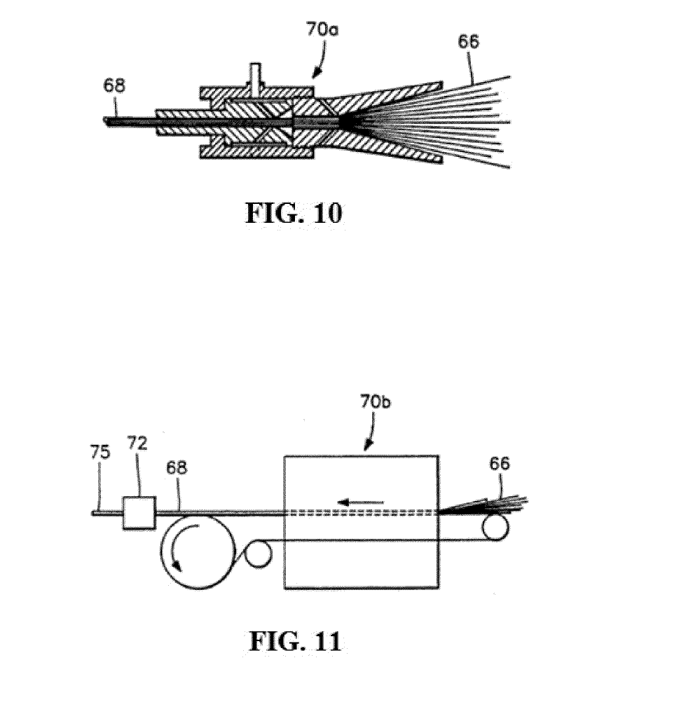

The remainder of the processing line seen in FIG. 7 may use apparatus known in the production of plasticized cellulose acetate tobacco smoke filter elements, although minor modifications may be required to individual elements thereof in order to facilitate heat bonding of the fibers. Exemplary apparatus will be seen, for example, in Berger U.S. Pat. Nos. 4,869,275, 4,355,995, 3,637,447 and 3,095,343 (the '275, '995, '447 and '343 patents, the subject matters of which are incorporated herein in their entirety by reference). The web or roving of melt blown sheath-core bicomponent fibers 60 is not bonded or very lightly bonded at this point and is pulled by nip rolls 62 into a stuffer jet 64 where it is bloomed as seen at 66 and gathered into a rod shape 68 in a heating means 70 which may comprise a heated air or steam die as shown at 70a in FIG. 10 (of the type disclosed in the '343 patent), or a dielectric oven as shown at 70b in FIG. 11. The heating means raises the temperature of the gathered web or roving above about 90° C. to cure the rod, first softening the sheath material to bond the fibers to each other at their points of contact, and then crystallizing the sheath material. The element 68 is then cooled by air or the like in the die 72 to produce a stable and relatively self-supporting, highly porous fiber rod 75. These may be formed from a web of the flexible thermoplastic fibrous material comprising an interconnecting network of highly dispersed continuous fibers randomly oriented primarily in a longitudinal direction and bonded to each other at points of contact to provide high surface area and very high porosity, preferably over 70% with at least a major portion, and preferably all of the fibers being bicomponent fibers comprising a continuous sheath material of homo- or co-polymer(s) of poly(m-xylene adipamide) or polyphenylene sulfide and the elements being dimensionally stable at temperatures over 100° C.

The method of making such substantially self-supporting elongated elements comprises combining bicomponent extrusion technology with melt blown attenuation to produce a web or roving of highly entangled fine fibers with a bondable sheath at a lower temperature than the melting point of the core material. The web or roving is gathered and heated to bond the fibers at their points of contact.

For ink reservoirs, the bonding of the fibers need only provide sufficient strength to form the rod and maintain the pore structure. Optionally, depending upon its ultimate use, the porous rod 75 can be coated with a plastic material in a conventional manner (not shown) or wrapped with a plastic film or a paper overwrap 76 as schematically shown at 78 to produce a wrapped porous rod 80. The continuously produced porous fiber rod 80, whether wrapped or not, may be passed through a standard cutter head 82 at which point it is cut into preselected lengths and deposited into an automatic packaging machine.

By subdividing the continuous porous rod, a multiplicity of discrete porous elements are formed, one of which is illustrated schematically in FIG. 6 at 90 having a hollow core 92. Each element 90 comprises an elongated air-permeable body of fine melt blown bicomponent fibers such as shown at 20 in FIG. 1, bonded at their contact points to define a high surface area, highly porous, self-supporting element having excellent capillary properties when used as a reservoir or wick and providing a tortuous interstitial path for passage of a gas or liquid when used as a filter. It is to be understood that elements 90 produced in accordance with this invention need not be of uniform construction throughout as illustrated in FIG. 6.

### Example

Melt blown filter tubes made of monocomponent nylon 6 (polycaprolactam) fiber (“Monocomponent Fiber Matrix”) and of sheath-core bicomponent fibers (sheath: poly(m-xylene adipamide and core: nylon 6) (“Bicomponent Fiber Matrix”) were tested to compare the extent to which the fiber matrices withstood pressure through the wall thickness of the filters. Both filter tubes had the same fiber size and density. Measurements of max load (lbf) and stiffness (lbf/in) were obtained (Table 1) from an Instron physical testing machine.

To test the strength of the fiber matrices, three (3) rectangular prism samples were cut from three (3) random positions on each filter. The top of the rectangular prisms represented the outside diameter of the filter and the bottom represented the inside diameter. Each sample was tested on the Instron machine, which applied vertical force to the top surface of the rectangular prisms, or the outside of the filter, which is the same direction of fluid flow through the filters under normal operating conditions. The increased stiffness and strength of the Bicomponent Fiber Matrix is demonstrated by the measurements of max load and stiffness. The Bicomponent Fiber Matrix demonstrated 4.4 times the average max load and 2.5 times the average stiffness of the Monocomponent Fiber Matrix.

TABLE 1

| Sample | Max Load (lbf) | Stiffness (lbf/in) |
|---|---|---|
| Monocomponent Fiber Matrix | | |
| Nylon 6 | | |
| 1 | 9.0 | 40.6 |
| 2 | 13.9 | 57.5 |
| 3 | 11.6 | 81.2 |
| Average: | 11.5 | 59.8 |
| Bicomponent Fiber Matrix | | |
| Sheath: poly(m-xylene adipamide) | | |
| Core: nylon 6 | | |
| 1 | 50.1 | 141.9 |
| 2 | 48.3 | 145.6 |
| 3 | 54.1 | 163.5 |
| Average: | 50.8 | 150.3 |

These significantly higher values obtained for max load and stiffness suggests that the Bicomponent Fiber Matrix can retain its matrix structure and pore size distribution under far greater forces and pressures as compared to the Monocomponent Fiber Matrix, therefore maintaining its filtration ability without an accompanying negative impact on pressure drop across the filter. In contrast, the Monocomponent Fiber Matrix, under force, is much more susceptible to collapsing, forfeiting their its pore structure and pore size distribution, and therefore failing as a filter and causing a massive increase in pressure drop, essentially rendering the filter useless for its original intent and purpose.

The non-limiting embodiments of the present invention described and claimed herein is not to be limited in scope by the specific embodiments disclosed herein, as these embodiments are intended as illustrations of several aspects of the invention. Indeed, various modifications of the invention in addition to those shown and described herein will become apparent to those skilled in the art from the foregoing description. Such modifications are also intended to fall within the scope of the appended claims

1. A melt blown bicomponent fiber comprising:
a first thermoplastic polymeric material; and
a second thermoplastic polymeric material comprising poly(m-xylene adipamide);
wherein the melt blown bicomponent fiber has a sheath-core configuration; and
wherein the core comprises the first thermoplastic material and the sheath comprises the second thermoplastic polymeric material.

2. The melt blown bicomponent fiber of claim 1, wherein the sheath completely surrounds the core.

3. The melt blown bicomponent fiber of claim 1, wherein the first thermoplastic polymeric material has a first melting point and the second thermoplastic polymeric material has a second melting point and wherein the first melting point is lower than the second melting point.

4. The melt blown bicomponent fiber of claim 1, wherein the first thermoplastic polymeric material is one or more homo- or co-polymer(s) of nylon 6 (polycaprolactam), nylon 6,6 (poly(hexamethylene adipamide)), polypropylene, and/or polybutylene terephthalate.

5. A nonwoven fiber web or roving comprising a plurality of the melt blown bicomponent fibers of claim 1 bonded to one another.

6. The nonwoven fiber web or roving of claim 5, wherein the plurality of the melt blown bicomponent fibers are thermally bonded to one another at spaced apart points of contact to define a porous structure that substantially resists crushing.

7. A self-supporting, three-dimensional porous element formed of the nonwoven fiber web or roving of claim 6.

8. An ink reservoir comprising the self-supporting, three-dimensional porous element of claim 7.

9. A wick for medical or diagnostic test devices comprising the self-supporting, three-dimensional porous element of claim 7.

10. A wick for air freshener or insecticide delivery devices comprising the self-supporting, three-dimensional porous element of claim 7.

11. A filter or filter element comprising the self-supporting, three-dimensional porous element of claim 7.

12. A polymeric fiber comprising:
a first thermoplastic polymeric material; and
a second thermoplastic polymeric material comprising homo- or co-polymers of poly(m-xylene adipamide) or polyphenylene sulfide.

13. The polymeric fiber of claim 12, wherein the first thermoplastic polymeric material is one or more homo- or co-polymer(s) of nylon 6 (polycaprolactam), nylon 6,6 (poly(hexamethylene adipamide)), polypropylene, and/or polybutylene terephthalate.

14. The polymeric fiber of claim 12, wherein the polymeric fiber is a melt blown bicomponent fiber.

15. The polymeric fiber of claim 14, wherein the melt blown bicomponent fiber has a sheath-core configuration, wherein the core comprises the first thermoplastic polymeric material and the sheath comprises the second thermoplastic polymeric material.

16. The polymeric fiber of claim 15, wherein the sheath completely encases the core.

17. The polymeric fiber of claim 14, wherein the melt blown bicomponent fiber has a configuration selected from the group consisting of: sheath-core, side-by-side, sheath-core multi-lobal, and tipped multi-lobal.

18. The polymeric fiber of claim 17, wherein the melt blown bicomponent fiber has a side-by-side configuration comprising first and second portions, the first portion comprising the first thermoplastic material and the second portion comprising the second thermoplastic material.

19. A nonwoven web of heterogeneous fibers comprising:
a plurality of bicomponent fibers comprising a first thermoplastic polymeric material and a second thermoplastic polymeric material comprising homo- or co-polymer(s) of poly(m-xylene adipamide) or polyphenylene sulfide; and
a plurality of fibers comprising a third thermoplastic polymeric material.

20. The nonwoven web of heterogeneous fibers of claim 19, wherein the first and third thermoplastic material each have a melting point that is lower than a melting point for the second thermoplastic polymeric material.

21. The nonwoven web of heterogeneous fibers of claim 19, wherein the first and third thermoplastic polymeric material are each separately selected from one or more homo- or co-polymer(s) of nylon 6 (polycaprolactam), nylon 6,6 (poly(hexamethylene adipamide)), polypropylene, and/or polybutylene terephthalate.

22. The nonwoven web of heterogeneous fibers of claim 19, wherein the bicomponent fibers each comprise a core comprising the first thermoplastic polymeric material and a sheath comprising the second thermoplastic polymeric material, wherein the sheath completely surrounds the core.

23. The nonwoven web of heterogeneous fibers of claim 22, wherein the first and third thermoplastic polymeric materials are each separately selected from one or more homo- or co-polymer(s) of nylon 6 (polycaprolactam), nylon 6,6 (poly(hexamethylene adipamide)), polypropylene, and/or polybutylene terephthalate.

24. The nonwoven web of heterogeneous fibers of claim 23, wherein the first and third thermoplastic polymeric materials comprise the same thermoplastic polymeric material.

25. A self-supporting, three-dimensional porous element comprising the nonwoven web of heterogeneous fibers of claim 22, wherein the bicomponent fibers are thermally bonded to one another and to the plurality of fibers at spaced apart points of contact to define a porous structure that substantially resists crushing.

26. A self-supporting, three-dimensional porous element consisting of:
a non-woven web of fibers, the fibers comprising bicomponent fibers comprising a first thermoplastic polymeric material and a second thermoplastic polymeric material comprising homo- or co-polymer(s) of poly(m-xylene adipamide) or polyphenylene sulfide.

27. The self-supporting, three-dimensional porous element of claim 26, wherein a melting point of the first thermoplastic polymeric material is lower than a melting point of the second thermoplastic polymeric material.

28. The self-supporting, three-dimensional porous element of claim 26, wherein the first thermoplastic polymeric material is one or more homo- or co-polymer(s) of nylon 6 (polycaprolactam), nylon 6,6 (poly(hexamethylene adipamide)), polypropylene, and/or polybutylene terephthalate.

29. The self-supporting, three-dimensional porous element of claim 26, wherein the fibers further comprise a plurality of fibers comprising a third thermoplastic polymeric material.

30. The self-supporting, three-dimensional porous element of claim 29, wherein the third thermoplastic polymeric material is one or more homo- or co-polymer(s) of nylon 6 (polycaprolactam), nylon 6,6 (poly(hexamethylene adipamide)), polypropylene, and/or polybutylene terephthalate.

31. The self-supporting, three-dimensional porous element of claim 29, wherein the third thermoplastic polymeric material is a monocomponent fiber.
